(19) United States
(12) Patent Application Publication
(10) Pub. No.: US 2026/0370472 A1
(43) Pub. Date: Nov. 19, 2026

(54) PERFORMING CRYPTOGRAPHIC OPERATIONS FOR DIGITAL ACTIVITY SECURITY

(71) Applicant: Entersekt International Limited, Cybercity, Ebene (MU)

(72) Inventor: Gerhard Gysbert OOSTHUIZEN, Cape Town (ZA)

(21) Appl. No.: 19/148,142

(22) PCT Filed: Feb. 13, 2024
(86) PCT No.: PCT/IB2024/051323

§ 371 Date: Jul. 15, 2025

(30) Foreign Application Priority Data
Feb. 14, 2023 (ZA) 2023/01759

(51) Int. Cl. H04L 9/32

(52) U.S. Cl. CPC H04L 9/3213; H04L 9/3271

(57) ABSTRACT

A system and method for performing cryptographic operations for digital activity security The method includes receiving a request message of a first type related to an activity. The request message includes an activity-related data element and is associated with a first indicator. A message including the activity-related data element is transmitted to a user communication device. A cryptographic token is received from the device, having been obtained from a trusted environment and including cipher text produced by the trusted environment signing the activity-related data element using a cryptographic key stored within the trusted environment. A request of a second type is initiated for the activity using the cryptographic token. The request of the second type is associated with a second indicator.

### CROSS-REFERENCE(S) TO RELATED APPLICATIONS

This application claims priority from South African provisional patent application number 2023/01759 filed on 14 Feb. 2023, which is incorporated by reference herein.

### FIELD

This technology relates to a system and method for performing cryptographic operations for digital activity security.

### BACKGROUND

A card-not-present (CNP) transaction typically refers to a card transaction made where the cardholder does not or cannot physically present the card for a merchant's visual examination at the time that an order is given. Such transactions are most common for transactions made over the Internet. Card-not-present transactions present a security risk, because it is difficult for a merchant to verify that the actual cardholder is indeed authorizing a purchase. Card-not-present transactions can in some cases be treated differently to so-called “card-present” (CP) transactions because they may, for example, entail a greater security risk.

Three-domain secure, also termed “3-D Secure,” refers to a protocol designed to provide an additional security layer for conducting transactions using cards where the card is not physically present. In a typical card-not-present transaction in which 3-D Secure is implemented, a cardholder uses a web browser or application on a cardholder device to visit a merchant website (“the merchant”). The cardholder provides user credentials associated with the card (e.g. a personal account number, card verification value, expiry date) to the merchant. The user credentials may be provided in order to make a payment in favour of the merchant (typically but not necessarily in exchange for goods or services).

The cardholder's web browser is typically redirected form the merchant to an access control server (ACS) associated with a domain of an issuer institution having issued the cardholder's card (“the issuer”). The ACS may be operated by the issuer institution or by a third party on behalf of the issuer institution. Redirection is typically via a directory service and a redirect URL provided by the ACS to a merchant plug-in (MPI).

Redirection may use a payer authentication request (PAReq) received from the directory service and may include directing the cardholder's browser to the ACS or by displaying in the merchant website an inline frame targeting the ACS. The ACS may then authenticate the cardholder for example by using a one-time password (OTP) or another appropriate form of authentication (e.g. submission of a predetermined passcode, etc.).

If the consumer is successfully authenticated, the ACS may redirect the cardholder's browser back to the merchant and may also transmit to the merchant a payer authentication response (PARes) that indicates whether authentication was successful, failed or could not be performed. The PARes may be signed by the ACS with an asymmetric signature that may be verified by the merchant's MPI.

The PARes may include one or more of: an authentication status, an electronic commerce indicator (ECI) indicating the result of the authentication process, and, depending on the specific implementation, a cardholder authentication verification value (CAVV), an accountholder authentication value (AAV), or a universal cardholder authentication field (UCAF) (hereafter referred to as a “verification value”). The verification value may include an authentication tracking number (ATN) and a cryptographic message authentication code (MAC), the latter of which may be a symmetric signature generated by the ACS and may include transaction details as an input.

The MPI may include the verification value and the ECI in an authorization request. The authorization request may further include the user credentials and possibly other transaction and cardholder-related information. The merchant may transmit the authorization request to an acquirer institution associated with the merchant. The acquirer institution may in turn forward the authorization request onwards to the issuer institution (typically via an acceptance network).

Upon receiving the authorization request, the issuer institution verifies the verification value (e.g. by verifying the MAC using a key that was used by ACS to generate the MAC as well as the transaction details). If the verification is successful, the transaction may be allowed to proceed (but could fail for other reasons, e.g. insufficient funds, etc.).

While the 3-D Secure protocol may help in alleviating security risks in card-not-present transactions, there remain disadvantages. For example, the 3-D Secure protocol relies to some extent on operations executed in an environment that is not trusted by the issuer domain, for example being the browser or application on the cardholder device. 3-D Secure-based card-not-present transactions may therefore still be associated with a higher security risk as compared to card-present transactions.

There is accordingly scope for improvement.

The preceding discussion of the background is intended only to facilitate an understanding of the present technology. It should be appreciated that the discussion is not an acknowledgment or admission that any of the material referred to was part of the common general knowledge in the art as at the priority date of the application.

### SUMMARY

In accordance with an aspect of the technology there is provided a computer-implemented method conducted at a first server computer comprising: receiving a request message of a first type related to an activity, the request message of the first type including a static data element and an activity-related data element and being associated with a first indicator, wherein the static data element is associated with a user communication device; transmitting a message including the activity-related data element to the user communication device, the message being configured to cause the user communication device to prompt a user thereof to perform a user action to initiate generation of a cryptographic token in a trusted environment which stores a user-side cryptographic key; receiving the cryptographic token from the user communication device, the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

The second indicator may be different from the first indicator. The first indicator may be a flag, label, attribute, request type or message type and the second indicator may be a different flag, label, attribute, request type or message type. The first and second indicators may trigger or cause initiation of different processing of requests with which they are associated. The first and second indicators may be usable by the acceptance network and/or an issuer to process requests differently, apply different rules or limits, or the like. The first indicator may indicate a first type of treatment and the second indicator may indicate a second type of treatment. The first indicator may be a first security risk indicator and the second indicator may be a second security risk indicator. The second security risk indicator indicates a lower security risk than the first security risk indicator.

The static data element may be a user-provided data element, and wherein the static data element is linked at an issuer to the trusted environment. The static data element may be linked to a server-side cryptographic key stored within a hardware security module and which corresponds to the user-side cryptographic key, wherein the server-side cryptographic key is usable in validating the cryptographic token. The user-side cryptographic key may be accessible to the trusted environment only.

The method may include identifying the user communication device associated with the static data element. The user communication device may be remote from the first server computer and the second server computer. The user communication device may be an out-of-band communication device. The message may be a cryptographic token request message or a confirmation and enrichment request message. The message may include a prompt to the user to approve or decline the activity, and wherein the user action is a user input approving the activity.

The trusted environment may be provided by a secure element embedded within the user communication device or provided on a smart card external to the user communication device. The user action may be a proximity-based presentation of the smart card to the user communication device. The cryptographic token may be obtained by the user communication device from the trusted environment via a proximity communication interface over which the user communication device transmits the activity-related data element to the trusted environment and the trusted environment transmits the cryptographic token to the user communication device.

The method may include processing the activity-related data elements to determine whether the activity-related data element exceeds predetermined threshold; and, identifying the user communication device in response to determining that the activity-related data element exceeds the predetermined threshold. The activity-related data element may represent an amount, and wherein the method includes transmitting the message to the user communication device when the amount exceeds a predefined threshold.

The request message of the first type may originate from a second server computer. Initiating the request of the second type for the activity using the cryptographic token may include transmitting a response message to the second server computer. Initiating the request of the second type may include transmitting the response message including the cryptographic token to the second server computer for transmission of a request message of the second type including the cryptographic token by the second server computer to the acceptance network. Alternatively, initiating the request of the second type may include the first server computer transmitting a request message of the second type including the cryptographic token to the acceptance network on behalf of the second server computer, and wherein the response message declines the request message of the first type.

The request message of the first type may have been generated at the second server computer responsive to the second server computer receiving the static data element from a remote user. The static data element may be received at the second server computer from the user communication device or from another device. The request message of the second type may include an ECI value indicating card-not-present.

The second server computer may be a 3DS requestor and the user may be a 3DS client in a security protocol. The request message of the first type may be one of: an Authentication Request Message (AReq) or a Challenge Request Message (CReq) in the security protocol. The response message may be one of: an Authentication Response Message (ARes), a Challenge Response Message (CRes) or a Results Request Message (RReq) in the security protocol.

In accordance with a further aspect of the technology there is provided a computer-implemented method conducted at a second server computer comprising: receiving a static data element from a remote user; transmitting, to a first server computer, a request message of a first type related to an activity and including the static data element and an activity-related data element, wherein the request message of the first type is associated with a first indicator; receiving, from the first server computer, a response message which indicates initiation of or is usable in initiating a request of a second type for the activity using a cryptographic token having been obtained by a user communication device from a trusted environment for transmission to an acceptance network, wherein the request of the second type is associated with a second indicator.

The response message may include the cryptographic token including cipher text produced by a trusted environment signing the activity-related data element with a user-side cryptographic key stored within the trusted environment, and wherein the method includes transmitting the cryptographic token to the acceptance network in a request message of the second type.

In accordance with a further aspect of the technology there is provided a computer-implemented method conducted at a user communication device comprising: receiving, from a first server computer, a message including the activity-related data element and being configured to cause the user communication device to prompt a user thereof to perform a user action to initiate generation of a cryptographic token by a trusted environment, the activity-related data element having been received at the first server computer with a static data element in a request message of a first type related to an activity, wherein the request message of the first type is associated with a first indicator; outputting, via an output component of the user communication device, a prompt to the user to perform the user action; in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with a user-side cryptographic key stored within the trusted environment; and, transmitting the cryptographic token to the first server computer for initiating a request of a second type for the activity using the cryptographic token for transmission to an acceptance network, wherein the request of the second type is associated with a second indicator.

In accordance with an aspect of the technology there is provided a computer-implemented method comprising: receiving an activity-related data element relating to an activity, wherein the activity-related data element are associated with a first indicator; in response to determining that the activity-related data element exceeds a predetermined threshold for the first indicator, causing a user communication device to prompt a user thereof to perform a user action to initiate, in a trusted environment which stores a user-side cryptographic key, generation of a cryptographic token based on the activity-related data element; receiving the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

In accordance with a further aspect of the technology there is provided a system including a memory for storing computer-readable program code and a processor for executing the computer-readable program code, the system comprising: a request message receiving component for receiving a request message of a first type related to an activity, the request message of the first type including a static data element and an activity-related data element and being associated with a first indicator, wherein the static data element is associated with a user communication device; a message transmitting component for transmitting a message including the activity-related data element to the user communication device, the message being configured to cause the user communication device to prompt a user thereof to perform a user action to initiate generation of a cryptographic token in a trusted environment which stores a user-side cryptographic key; a cryptographic token receiving component for receiving the cryptographic token from the user communication device, the cryptographic token having been obtained by the user communication device from the trusted environment and including cipher text produced by the trusted environment signing the activity-related data element with the user-side cryptographic key stored within the trusted environment; and, an initiating component for initiating a request of a second type for the activity using the cryptographic token for transmission to an acceptance network, wherein the request of the second type is associated with a second indicator.

In accordance with a further aspect of the technology there is provided a system including a memory for storing computer-readable program code and a processor for executing the computer-readable program code, the system comprising: static data element receiving component for receiving a static data element from a remote user; a request message transmitting component for transmitting, to a first server computer, a request message of a first type related to an activity and including the static data element and an activity-related data element, wherein the request message of the first type is associated with a first indicator; a response message receiving component for receiving, from the first server computer, a response message which indicates initiation of or is usable in initiating a request of a second type for the activity using a cryptographic token having been obtained by a user communication device from a trusted environment for transmission to an acceptance network, wherein the request of the second type is associated with a second indicator.

In accordance with a further aspect of the technology there is provided a system including a memory for storing computer-readable program code and a processor for executing the computer-readable program code, the system comprising: a message receiving component for receiving, from a first server computer, a message including an activity-related data element and being configured to cause the user communication device to prompt a user thereof to perform a user action to initiate generation of a cryptographic token by a trusted environment, the activity-related data element having been received at the first server computer with a static data element in a request message of a first type related to an activity, wherein the request message of the first type is associated with a first indicator; a prompt outputting component for outputting, via an output component of the user communication device, a prompt to the user to perform the user action; a cryptographic token obtaining component for, in response to the user performing the user action, obtaining the cryptographic token from the trusted environment, including transmitting the activity-related data element to the trusted environment and receiving the cryptographic token from the trusted environment, the cryptographic token including cipher text produced by the trusted environment signing the activity-related data element with a user-side cryptographic key stored within the trusted environment; and, a cryptographic token transmitting component for transmitting the cryptographic token to the first server computer for initiating a request of a second type for the activity using the cryptographic token for transmission to an acceptance network, wherein the request of the second type is associated with a second indicator.

In accordance with a further aspect of the technology there is provided a system including a first server computer comprising: a first non-transitory computer-readable storage medium; and one or more first processors coupled to the non-transitory computer-readable storage medium, wherein the first non-transitory computer-readable storage medium comprises program instructions that, when executed on the one or more first processors, cause the first server computer to perform operations comprising: receiving a request message of a first type related to an activity, the request message of the first type including a static data element and an activity-related data element and being associated with a first indicator, wherein the static data element is associated with a user communication device; transmitting a message including the activity-related data element to the user communication device, the message being configured to cause the user communication device to prompt a user thereof to perform a user action to initiate generation of a cryptographic token in a trusted environment which stores a user-side cryptographic key; receiving the cryptographic token from the user communication device, the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

The system may include the second server computer comprising: a second non-transitory computer-readable storage medium; and one or more second processors coupled to the second non-transitory computer-readable storage medium, wherein the second non-transitory computer-readable storage medium comprises program instructions that, when executed on the one or more second processors, cause the second server computer to perform operations comprising: receiving the static data element from a remote user; transmitting, to the first server computer, the request message of the first type related to the activity and including the static data element and the activity-related data element; receiving, from the first server computer, a response message which indicates initiation of or is usable in initiating the request of the second type for the activity using the cryptographic token having been obtained by the user communication device from the trusted environment for transmission to the acceptance network.

The system may include the user communication device comprising: a device non-transitory computer-readable storage medium; and one or more device processors coupled to the device non-transitory computer-readable storage medium, wherein the device non-transitory computer-readable storage medium comprises program instructions that, when executed on the one or more device processors, cause the user communication device to perform operations comprising: receiving, from the first server computer, the message including the activity-related data element and being configured to cause the user communication device to prompt a user thereof to perform the user action to initiate generation of the cryptographic token by the trusted environment, the activity-related data element having been received at the first server computer with the static data element in the request message of the first type related to the activity and originating from the second server computer; outputting, via an output component of the user communication device, a prompt to the user to perform the user action; in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with the user-side cryptographic key stored within the trusted environment; and, transmitting the cryptographic token to the first server computer for initiating the request of the second type for the activity using the cryptographic token for transmission to the acceptance network.

The static data element may be linked at an issuer to the trusted environment. The static data element may be linked to a server-side cryptographic key stored within a hardware security module and which corresponds to the user-side cryptographic key. The server-side cryptographic key may be usable in validating the cryptographic token. The trusted environment may be provided by a secure element embedded within the user communication device or provided on a smart card external to the user communication device.

In accordance with a further aspect of the technology there is provided a system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising: receiving an activity-related data element relating to an activity, wherein the activity-related data element is associated with a first indicator; in response to determining that the activity-related data element exceeds a predetermined threshold for the first indicator, causing a user communication device to prompt a user thereof to perform a user action to initiate, in a trusted environment which stores a user-side cryptographic key, generation of a cryptographic token based on the activity-related data element; receiving the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

In accordance with a further aspect of the technology there is provided a computer program product comprising a computer-readable medium having stored computer-readable program code for performing the steps of: receiving a request message of a first type related to an activity, the request message of the first type including a static data element and an activity-related data element and being associated with a first indicator, wherein the static data element is associated with a user communication device; transmitting a message including the activity-related data element to the user communication device, the message being configured to cause the user communication device to prompt a user thereof to perform a user action to initiate generation of a cryptographic token in a trusted environment which stores a user-side cryptographic key; receiving the cryptographic token from the user communication device, the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

In accordance with a further aspect of the technology there is provided a computer program product comprising a computer-readable medium having stored computer-readable program code for performing the steps of: receiving a static data element from a remote user; transmitting, to a first server computer, a request message of a first type related to an activity and including the static data element and an activity-related data element, wherein the request message of the first type is associated with a first indicator; receiving, from the first server computer, a response message which indicates initiation of or is usable in initiating a request of a second type for the activity using a cryptographic token having been obtained by a user communication device from a trusted environment for transmission to an acceptance network, wherein the request of the second type is associated with a second indicator.

In accordance with a further aspect of the technology there is provided a computer program product comprising a computer-readable medium having stored computer-readable program code for performing the steps of: receiving, from a first server computer, a message including an activity-related data element and being configured to cause the user communication device to prompt a user thereof to perform a user action to initiate generation of a cryptographic token by a trusted environment, the activity-related data element having been received at the first server computer with a static data element in a request message of a first type related to an activity, wherein the request message of the first type is associated with a first indicator; outputting, via an output component of the user communication device, a prompt to the user to perform the user action; in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with a user-side cryptographic key stored within the trusted environment; and, transmitting the cryptographic token to the first server computer for initiating a request of a second type for the activity using the cryptographic token for transmission to an acceptance network, wherein the request of the second type is associated with a second indicator.

In accordance with a further aspect of the technology there is provided a computer program product comprising a computer-readable medium having stored computer-readable program code for performing the steps of: receiving an activity-related data element relating to an activity, wherein the activity-related data element is associated with a first indicator; in response to determining that the activity-related data element exceeds a predetermined threshold for the first indicator, causing a user communication device to prompt a user thereof to perform a user action to initiate, in a trusted environment which stores a user-side cryptographic key, generation of a cryptographic token based on the activity-related data element; receiving the cryptographic token having been obtained by the user communication device from the trusted environment and including cipher text produced by the trusted environment signing the activity-related data element with the user-side cryptographic key stored within the trusted environment; and, initiating a request of a second type for the activity using the cryptographic token for transmission to an acceptance network, wherein the request of the second type is associated with a second indicator.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

In the drawings:

FIG. 1 is a schematic diagram which illustrates an example embodiment of a system for performing cryptographic operations for digital activity security according to aspects of the present disclosure;

FIG. 2 is a schematic diagram which illustrates a linking between accounts and smart cards and associated information of a user;

FIG. 3A is a flow diagram which illustrates an exemplary method for performing cryptographic operations in a trusted environment according to aspects of the present disclosure;

FIG. 3B is a swim-lane flow diagram which illustrates an exemplary method for performing cryptographic operations for digital activity security according to aspects of the present disclosure;

FIG. 4A illustrates an example prompt that may be output by a user communication device according to aspects of the present disclosure;

FIG. 4B illustrates another example prompt that may be output by a user communication device according to aspects of the present disclosure;

FIG. 4C illustrates another example prompt that may be output by a user communication device according to aspects of the present disclosure;

FIG. 5 is a swim-lane flow diagram which illustrates an exemplary method for obtaining a cryptographic token according to aspects of the present disclosure;

FIG. 6 is a schematic diagram which illustrates an example embodiment of a method for performing cryptographic operations for digital activity security integrated into a security protocol;

FIG. 7 is a schematic diagram which illustrates another example embodiment of a method for performing cryptographic operations for digital activity security integrated into a security protocol;

FIG. 8A is a block diagram which illustrates exemplary components which may be provided by a system for performing cryptographic operations for digital activity security according to aspects of the present disclosure;

FIG. 8B is a block diagram which illustrates exemplary components which may be provided by a system for performing cryptographic operations for digital activity security according to aspects of the present disclosure; and,

FIG. 9 illustrates an example of a computing device in which various aspects of the disclosure may be implemented.

### DETAILED DESCRIPTION WITH REFERENCE TO THE DRAWINGS

Aspects of the present disclosure relate to a system and method for performing cryptographic operations for digital activity or digital event security. The cryptographic operations may be performed in a trusted environment. In the described system and method, a set of activity-related data elements relating to a digital activity or a digital event may be received, for example by way of user input into a user communication device. The set of activity-related data elements may be associated with a first indicator. For example, the set of activity-related data elements may describe or relate to a digital activity that is typically handled in a manner that is associated with a first indicator. A data element of the set of activity-related data elements may be determined to exceed a predetermined threshold for the first indicator. In response to the determination, a user communication device may be caused to prompt a user thereof to perform a user action to initiate, in a trusted environment, generation of a cryptographic token based on the set of activity-related data elements. The trusted environment may for example generate a cryptographic token including cipher text produced by the trusted environment signing the set of activity-related data elements with a user-side key stored within the trusted environment. The cryptographic token may be received and a request of a second type for the activity may be initiated using the cryptographic token for transmission to an acceptance network. The request of the second type may be associated with a second indicator. The request of the second type may be associated with the second indicator by virtue of inclusion of the cryptographic token generated in the trusted environment.

The second indicator may be different from the first indicator. The first indicator may for example be a flag, label, attribute, request type or message type and the second indicator may for example be a different flag, label, attribute, request type or message type. The first and second indicators may trigger or cause initiation of different processing of requests with which they are associated.

The first and second indicators may be usable by the acceptance network and/or an issuer to process requests differently, apply different rules or limits, or the like. The first indicator may indicate a first type of treatment and the second indicator may indicate a second type of treatment. In some examples, the first indicator may be a first security risk indicator and the second indicator may be a second security risk indicator. The second security risk indicator indicates a lower security risk than the first security risk indicator.

In some examples of the described system and method, a request message of a first type for an activity may be converted or substituted with a request message of a second type for the activity. The request message of the first type may be associated with a first indicator. The request message of the second type may be associated with a second indicator. The conversion or substitution (“type-conversion”) may be based on cryptographic operations performed within a trusted environment which lowers the security risk associated with the activity. The type-conversion may take place in real-time, for example during pendency (before finalization or completion) of the activity. The type-conversion may be subject to the availability of a user communication device and a trusted environment either embedded therein or physically proximate thereto and in proximity-based data communication therewith. The user communication device may be physically remote from an originating server computer from which the request message of the first type originates. In some cases, the user communication device may be an out-of-band device in that initially it does not play a role in the activity. For example, in some cases, the user communication device may be invoked to enable the type-conversion, for example when one or more predetermined conditions relating to the activity are met.

The request message of the first type may have been generated based on and may include a first set of information which is not sufficient for the generation of a request message of the second type. For example, the first set of information may be static information. In some examples, the first set of information is ‘card-not-present’ information, such as one or more of a primary account number (PAN), card verification value (CVV) and expiry date. The first set of information may be provided to the originating server by a remote user, for example via the Internet.

The request message of the first type may be a consent request message or a payment request message. In some examples, the request message of the first type may be a security protocol request message requesting user consent or approval for the activity. In other examples, the request message of the first type may be a payment request message. The payment request message may for example be received in an open banking-based transaction system. In such an implementation, for example, an originating server computer may send a payment request message to a first server computer requesting payment relating to an activity. The payment request message may be provided in terms of an application programming interface (API), for example being a financial grade or financial institution API (FAPI).

Aspects of the present disclosure enable conversion from the first type of request message to the second type of request message when the user communication device is available and is able to provide sufficient information, being a second set of information, for the generation of a request message of the second type. The user communication device may obtain this second set of information from a trusted environment, which may be provided by a secure element of: the user communication device; or, a smart card (SC) (e.g. a “chip card” or “integrated circuit card (ICC)”) in proximity and/or contactless communication with the user communication device. The second set of information may be dynamic information in that it may be dynamically generated for the activity. For example, the second set of information may be uniquely linked to the digital activity to which the first request message relates. For example, the second set of information may be generated based on or may include at least a data element (or a set of data elements) received in the request message of the first type and related to the activity. In some embodiments, the second set of information may include or be in the form of a cryptographic token generated by the trusted environment using a user-side cryptographic key stored within the trusted environment. In some examples, the second set of information is ‘card-present’ information, including one or more of a cryptographic token, full track 2 data and the like. The request message of the second type may include the second set of information.

Aspects of the present disclosure may therefore enable the first set of information to be replaced or augmented with the second set of information such that the request message of the first type can be replaced with the request message of the second type. The type-conversion can be performed because of the cryptographic token having been generated in a trusted environment. Thus, for example, the cryptographic token can be assigned or regarded with a higher level of trust as compared to a token not having been generated in a trusted environment. Or, put another way, the cryptographic may be harder to spoof or it may be more difficult for miscreants to generate spurious cryptographic tokens. Real-time digital transaction type conversion may therefore be enabled. The type-conversion may enable more favourable treatment of the activity, for example through: a lower fee; and, higher approval rate (success rate) on account of the stronger (second set of) information which may mean that, for example, digital transaction limits might be different. The type conversion may achieve a higher rate of approval, stronger security, lower cost, and the like.

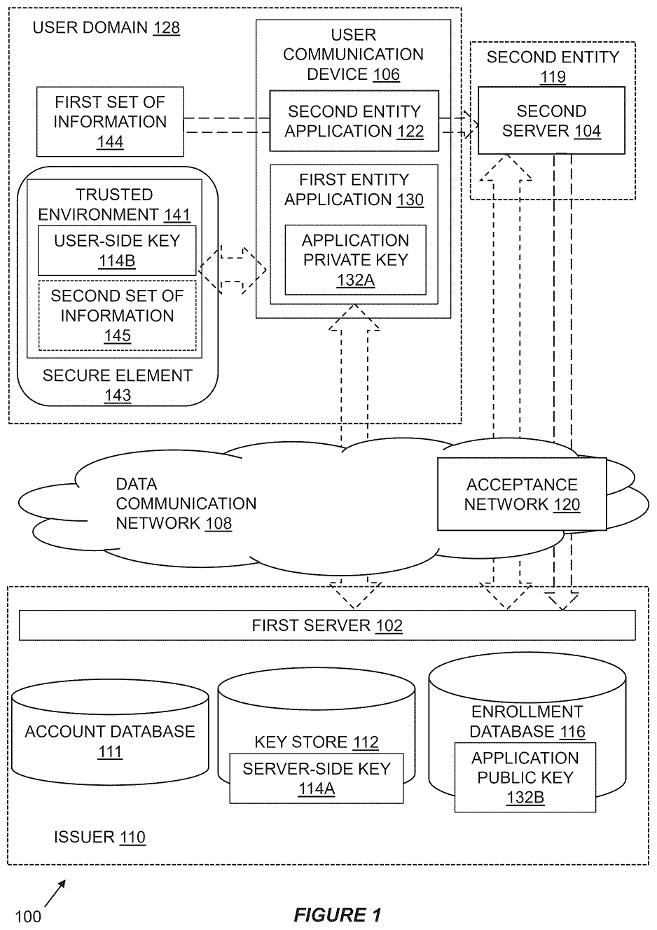

FIG. 1 is a schematic diagram which illustrates an example embodiment of a system (100) for performing cryptographic operations for digital activity security according to aspects of the present disclosure. The system may include a first server computer (102), a second server computer (104) and a user communication device (106), each of which communicates via a data communication network (108).

The first server computer (102) may be in the form of a computing device configured to perform a server role. In some examples, the first server computer (102) is maintained, operated and/or under the control of a first entity, being an issuer (110) of user credentials. The issuer (110) may for example maintain and/or have access to an account database (111) in which details relating to an account of a user may be stored. The issuer (110) may maintain and/or have access to a key store (112) which stores a server-side cryptographic key (114A). The server-side cryptographic key (114A) corresponds to a user-side cryptographic key (114B) provisioned to a trusted environment (141) which is accessible to the user communication device. The server-side and user-side cryptographic keys may be provisioned for a user secure element (143) which is linked to the account and issued by the issuer to the user. The user credential may for example include one or more of: a primary account number, card verification value, expiry date, cardholder name and the like. The server-side cryptographic key (114A) may be stored in association with the user, the user credential and/or the account. The key store (112) may be stored in a hardware security module (HSM).

The first server computer (102) may have access to an enrollment database (116) in which information relating to the user communication device (106) is stored in association with the user. The user communication device may have been enrolled by the user with the issuer. Information relating to the user communication device may have been stored in the enrollment database in association with the user responsive to an enrollment process.

The enrollment process may require the user of the user communication device to provide sufficient identifying information such that the user communication device can be enrolled with the issuer and linked to the user in the enrollment database for the purpose of enabling use of the user communication device to conduct transactions and other activities against, or otherwise interact with, the account. Example enrollment processes include the user physically visiting a bricks-and-mortar outlet of the issuer to present the user communication device and identifying information of the user; the user providing website login details to the issuer via the user communication device, the login details being details such as a username and password via which the user accesses the account online using a web browser; the user providing identifying information such as a national identity number and biometric information (such as a photograph of the user's face) to the issuer via the user communication device for verification by the issuer.

The enrollment database may store identifying information of the user communication device (such as one or both of a device identifier and a first entity application identifier, and the like) and identifying information of the user (such as a unique identifier assigned to the user for use in linking different records across the issuer to the user, or the like). In this manner, the user communication device is enrolled with the issuer for use by the user in transacting against and/or interacting with the account remotely using the user communication device. The enrollment database may be provided for the issuer to establish communication with the user (for example to approve or decline activities requested against to the account) and for the user to establish communication with the issuer (for example to submit payment instructions, view account balances, add beneficiaries and the like).

The second server computer (104) may be in the form of a computing device configured to perform a server role. The second server computer may be maintained, operated and/or under the control of a second entity (119), which may for example provide goods and/or services for sale, consumption, subscription or the like. The second server computer may for example be an e-commerce server computer of an online retailer, merchant, service provider or the like. The second server computer (104) may be configured to submit request messages to and receive response messages from an acceptance network (120) for processing requests relating to an activity.

The second server computer may be remotely accessible to the user via a website or a second entity application (122) provided by the second entity. The website or second entity application (122) may provide a mechanism for the user to provide to the second server computer over the data communication network (108) a first set of information relating to an activity of the user, for example for the remote purchase of goods, subscription to services or the like. In some examples, the second server computer may be configured as a 3DS requestor or equivalent in a three-domain secure (3DS) or equivalent security protocol.

The acceptance network (120) may include one or more of: a directory service; a payment processing network (such as VisaNet™ or equivalent); a server computer of an acquiring institution (e.g. being the second entity's acquirer) or the like. Communication with the acceptance network may be via the data communication network (in some cases using proprietary components, protocols or the like).

The user communication device (106) may be in the form of a computing device having a communication capability, such as a smart phone, tablet computer, personal computer, wearable computing device or the like. The user communication device (106) may be uniquely identifiable by way of identifying information. The user communication device may be enrolled at the issuer (110) in association with the user. The identifying information of the user communication device may be stored in the enrollment database (116) in association with identifying information of the user.

In some examples, a first entity application (130) executes on the user communication device. The first entity application may be trusted, provided, maintained and/or controlled by the issuer (110). The first entity application may for example be an issuer application, for example a banking application. The first entity application may be provided for download and installation from a third-party application repository. In some examples, the first entity application may be enrolled at the issuer in association with the user. In some examples, the identifying information of the user communication device is or includes an identifier which uniquely identifies the first entity application.

The identifying information may take various forms. In some examples, the identifying information includes one or more identifiers generated by the user communication device and/or the first entity application. In some examples, the identifier is a two-part identifier with the first part being an application private key (132A) and the second part being an application public key (132B) which may be stored separately from each other. The private key may be securely stored in the user communication device and the public key may be securely stored in the enrollment database (116) during enrollment of the user communication device or first entity application. The user communication device and/or first entity application may identify itself to the first server computer and/or issuer by signing a challenge, received from the first server computer, using the private key which can then be returned to and verified by the first server computer using the corresponding public key. The public key and private key pair may be generated by the user communication device and/or first entity application. The private key may be known only to the user communication device and/or first entity application. In other examples, symmetric encryption keys may be used in place of the asymmetric public and private key pair.

The issuer may issue the user with a user-side cryptographic key (114B) which corresponds to the server-side cryptographic key (114A). The user-side cryptographic key may be provisioned to a trusted environment (141). The trusted environment (141) may be hosted or provided by a secure element (143) within the user communication device, a smart card or another device. The user-side cryptographic key may be provisioned for the user credential linked to the account. In some examples, the trusted environment (141) may be embodied in or provided by a secure element of a physical smart card or of the user communication device to which a digitized or virtual smart card is provisioned. The digitized smart card may be accessible from a digital wallet provided by the user communication device. The trusted environment may have access to one or more user-side cryptographic keys. In some examples, for given user credentials, the user may have a trusted environment for each of: a physical smart card; and, a digitized smart card corresponding to the physical smart card and stored in a digital wallet of the user communication device.

The trusted environment (141) securely stores the user-side cryptographic key (114B). In this manner, data elements can be signed within the trusted environment using the user-side cryptographic key (114B). The signed data elements can be validated by the issuer using the server-side cryptographic key (114A) stored in the key store. In some examples, the trusted environment is configured for use in EMV-based methods.

The user-side cryptographic key may be associated with a first set of information (144) and a second set of information (145). The first set of information may be static while the second set of information may be dynamic in that it is generated on demand for an activity. The first set of information may for example be human readable and interpretable (e.g. embossed or printed on a portable credential device). In some embodiments, the first set of information may include one or more of: a PAN; a CVV or equivalent; a cardholder name; and, an expiry date. The second set of information may be unique to the activity for which it is generated. The second set of information may be dynamically generated within the trusted environment for an activity, such that it is unique to that activity. The second set of information may be generated using information stored in the trusted environment, such as the user-side cryptographic key (114B). The second set of information may include one or more of: a cryptographic token generated using the user-side key; track 2 data or track 2 equivalent data and the like. Some elements of the first set of information and second set of information may be the same. For example, both sets of information may include one or more of the PAN, CVV, cardholder name and expiry date.

The trusted environment (141) may be configured to generate a cryptographic token by signing data elements using the user-side cryptographic key (114B). The cryptographic token may include cipher text produced by the trusted environment signing the set of activity-related data elements with the user-side cryptographic key stored within the trusted environment. The cryptographic token may for example be (or be equivalent to) one of: a Transaction Certificate (TC); and Authorization Request Cryptogram (ARQC) generated according to the EMV method. The cryptographic token may be a digital signature of the set of activity-related data elements, which the issuer can check in real time.

In one example of the described system, the user may provide the first set of information (144) to the second server computer (104) via the browser or second entity application (122) pursuant to the user conducting an activity. The second server computer (104) may then submit the first set of information to the first server computer (102), via the acceptance network (120) (which may include and be via a directory service), in a request message of the first type (e.g. being a card-not-present request message) which includes a set of data elements relating to the activity. The request message of the first type may be associated with (e.g., by including a flag, label or designation of) a first indicator. Responsive to receiving the request message, the first server computer (102) may transmit the set of data elements to the user communication device (106). The user communication device provides the set of data elements to the trusted environment (141) and receives a second set of information, including a cryptographic token generated by the trusted environment signing the set of data elements using the user-side cryptographic key (114B). The user communication device returns the second set of information to the first server (102). The first server can then use the second set of information to initiate a request message of a second type for the activity. The request message of the second type may be associated with (e.g., by including a flag, label or designation of) a second indicator. The request message of the second type may for example be a card-present request for the activity using the second set of information for transmission to an acceptance network. In some implementations, this may include transmitting a response message including the cryptographic token to the second server computer for transmission of the request message of the second type including the cryptographic token by the second server computer to the acceptance network. Alternatively, in other implementations, this may include the first server computer transmitting the request message of the second type including the cryptographic token to the acceptance network on behalf of the second server computer.

It should be appreciated that in some examples the user communication device (106) may be an out-of-band device in that it is initially not a part of the digital activity flow. For example, the user may access the browser or second entity application (122) via another computing device which is not the user communication device. The first server computer may transmit the set of activity-related data elements to the user communication device in a message, such as a confirmation and enrichment request message which also requests confirmation of the user's intention to conduct the transaction.

The user communication device (106), secure element (143) providing the trusted environment (141) and browser or second entity application (122) may be within a user domain (128), in that they are accessible to the user and usable by the user in conducting the activity.

One or more or all of the account database (111), key store (112) and enrollment database (116) may store a user record associated with a user identifier. Each of the account, server-side cryptographic key (114A) and application public key (132B) and any other information stored in association therewith may therefore be associated with or linked to the user and/or with each other. In this manner, for example, the static data element may be said to be associated with the user communication device. For example, the static data element may be linked to the user's account stored in the account database, which is linked (by way of a unique user identifier) to the user record in the enrollment database, which in turn is linked to the user communication device via the public key and other associated information.

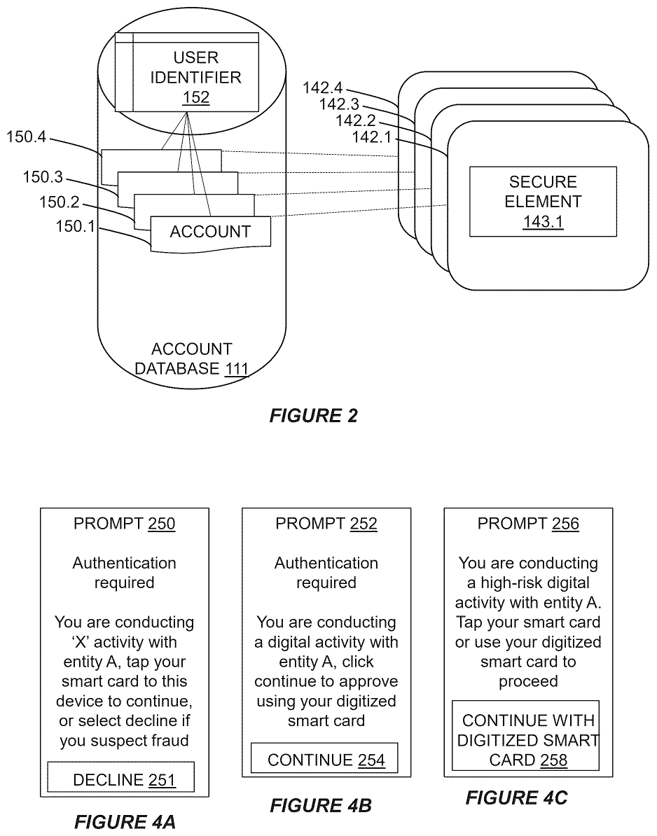

Above, the system has been described as including only a single user, user communication device, trusted environment, second server computer, etc. and it should be appreciated that in a practical implementation there may be a plurality of each of these. In particular, and referring now to FIG. 2, in a practical implementation, a single user may be associated with a plurality of smart cards (142.1, 142.2, 142.3, 142.4) each having its own secure element. The secure element of each smart card may store its own, unique user-side cryptographic key corresponding to a server-side cryptographic key which is unique for that smart card. Each smart card may be associated with its own first set of information, for example including user credentials being unique to that smart card. The user credentials of each smart card may identify and be associated with a corresponding account (150.1, 150.2, 150.3, 150.4) stored in the account database (111) in association with a user identifier (152). In this way, it should be appreciated that a first set of information of a first integrated card (e.g. 142.1) can be said to be associated with another (e.g. second (150.2) account because both are associated with the user via the account database. In the same manner, a user-side key of the second smart card (142.2) may be said to be associated with the first set of information of the first smart card (142.1). In this way, at the time of reaching out to the user for confirmation and enrichment, the issuer may allow the user the option of using a different integrated circuit card for the digital activity.

The system (100) described above may implement a method for performing cryptographic operations for digital activity security.

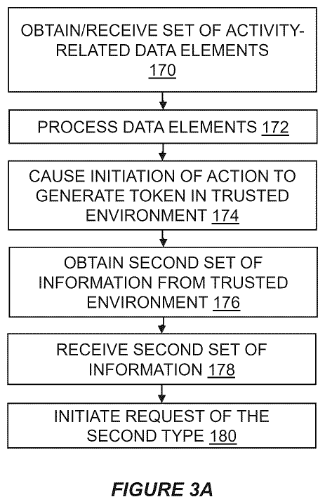

An exemplary method for performing cryptographic operations for digital activity security is illustrated in the flow diagram of FIG. 3A. The method may be conducted by one or more computing devices, such as one or both of the second server computer (104) and user communication device (106) as described above with reference to FIG. 1.

The method may include obtaining, deriving or receiving (170) a set of activity-related data elements relating to an activity.

The set of activity-related data elements may be obtained or derived from the user via user input into a computing device, such as the user communication device or another computing device accessible to the user. In some examples, the set of activity-related data elements are obtained or derived from input into a second entity application (122) or browser executing on the user communication device. In other examples, the set of activity-related data elements are obtained or derived from input into a second entity application (122) or browser executing on another computing device to which the user has access.

The set of activity-related data elements may be transmitted from the device into which they are input to the second server computer (104). In some examples, the set of activity related data elements are transmitted to the second server computer together with a first set of information (144). In other examples, the first set of information is already stored at the second server computer, for example having been provided by the user to the second server computer previously.

The set of activity-related data elements and/or first set of information may be associated with a first indicator. This may be by virtue of the data elements being associated with an activity of a first type, for example by virtue of being received from a device/user which is remote from the second server computer. In some cases, the set of activity related data elements are associated with a first indicator by virtue of being received together with or in association with the first set of information.

The method may include processing (172) the data elements to determine whether a data element of the set of activity-related data elements exceeds a threshold predetermined for that data element given that the data elements are associated with the first indicator. This may include checking one or more data elements against corresponding thresholds or limits, or the like. If the one or more data elements do not exceed the corresponding predetermined threshold, the digital activity may progress as normal.

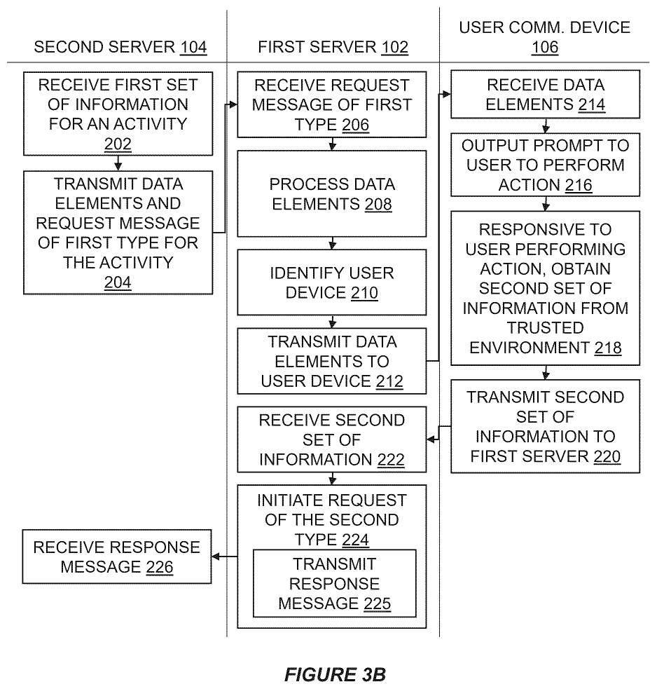

Otherwise, the method may include, in response to determining that the data element of the set of activity-related data elements exceeds the predetermined threshold for the first indicator, causing (174) the user communication device to prompt a user thereof to perform a user action to initiate, in a trusted environment which stores a user-side cryptographic key, generation of a cryptographic token based on the set of activity-related data elements. This may include causing the user communication device to output a prompt, such as one of the example prompts in FIGS. 4A-4C. The prompt may be output by the second entity application (122) or the browser. In some examples, the second entity application or browser may invoke or initialise the first entity application (130) which in turn outputs the prompt to the user.

The method may include obtaining (176) a second set of information from the trusted environment. The second set of information may include a cryptographic token generated based on the data elements using the user-side cryptographic key. The cryptographic token may include cipher text produced or generated by the trusted environment signing the set of activity-related data elements with the user-side key stored within the trusted environment.

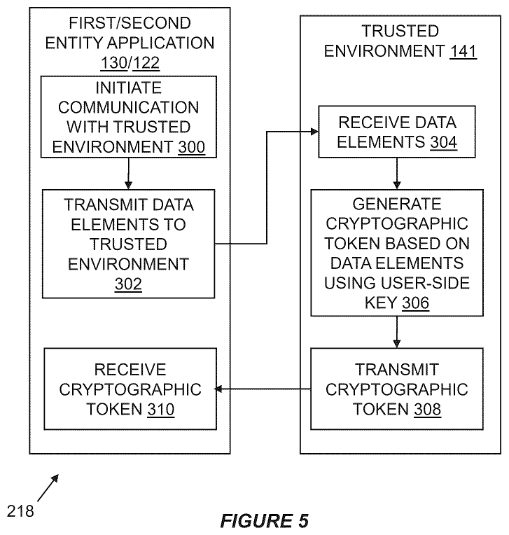

The second set of information may be obtained by the user communication device (e.g., as described below with reference to FIG. 5). The second set of information may be obtained by the first entity application (130) or second entity application (122) executing on the user communication device. This may include transmitting the set of activity related data elements to the trusted environment and, in response, receiving the second set of information from the trusted environment. The user communication device may transmit the second set of information to a first server computer (102) or the second server computer (104). The second set of information may be received at the first server computer or second server computer. The method may include receiving (178) the second set of information including the cryptographic token having been obtained by the user communication device from the trusted environment.

The method may include initiating (180) a request of a second type for the activity using the second set of information including the cryptographic token for transmission to an acceptance network. The request of the second type may be associated with a second indicator. In some examples, the first indicator is a first security risk indicator and the second indicator is a second security risk indicator. The second security risk indicator may indicate a lower security risk than the first security risk indicator.

Another exemplary method for performing cryptographic operations for digital activity security is illustrated in the swim-lane flow diagram of FIG. 3B in which respective swim-lanes delineate steps, operations or procedures performed by respective entities or devices. The description of FIG. 3B elaborates on one example implementation of the method described above with reference to FIG. 3A.

In the method, the user may be conducting an activity with the second entity, for example entering into a digital transaction with the second entity. The user and the second entity may be remote from each other and the user may interact with the second server computer (104) of the second entity using a browser or second entity application (122) executing on a computing device, which may be the user communication device (106) or another computing device accessible to the user. In some embodiments, a first entity application (130) executes on the user communication device, in which embodiment the steps or operations described below as being executed on the user communication device may executed or performed by the first entity application.

In conducting the activity, the user may provide the first set of information (144) to the second entity, for example by inputting the first set of information into the browser or second entity application for transmission to the second server computer via the data communication network (108). It may be that the browser or second entity application (122) (being a separate application from the first entity application (130)) executes on the user communication device, but this is not required and the first set of information may be provided from any computing device accessible to the user. The first set of information includes one or more static data elements, such as one or more of a PAN, tokenized PAN, wallet identifier or other form of account identifier. The user may input the first set of information on a per activity basis (e.g. each time the user conducts a digital transaction with the second entity) or only once for secure storage by the second entity and for use in relation to subsequent activities. The user may in this manner be operating as a 3DS client in a 3DS or equivalent security protocol.

The second server computer (104) receives or obtains (202) the first set of information including the at least one static data element. The first set of information may be received from the user via the data communication network (108) or obtained or retrieved from a secure storage of the second entity which is accessible to the second server computer. The first set of information is received in relation or pursuant to the user conducting an activity with the second entity, such as making a purchase, subscribing to a service or the like.

The second server computer (104) transmits (204) a request message of the first type to the first server computer (102). The request message of the first type may be generated and transmitted from the second server computer (104) responsive or due to the second server computer receiving or obtaining the first set of information, including the at least one static data element, from a user via the data communication network. The request message may include the first set of information and a set of data elements relating to the activity. In some examples, one of the data elements in the set of data elements represents an amount associated with the activity, for example being a purchase price, subscription cost or the like. Other data elements within the set of activity-related data elements may include one or more of: a second entity identifier which identifies the second entity, an electronic commerce indicator (ECI) value, an entity category code (or a merchant category code), details relating to the activity (e.g. category of goods/services, description of goods/services, etc.) and the like.

The request message of the first type may be transmitted from the second server computer to the first server computer via an acceptance network (120) and/or a directory service. The request message of the first type may be associated with a first security risk indicator. The request message of the first type may for example be a card-not-present request message related to the activity. The request message of the first type may include the first set of information. In some embodiments, the request message of the first type includes an ECI value indicating card-not-present. In some embodiments, the request message of the first type is one of: an Authentication Request Message (AReq); a Challenge Request Message (CReq); or equivalent request message used in three-domain secure (3DS) or equivalent security protocol designed to be an additional security layer for online credit and debit card transactions.

The first server computer (102) may receive (206) the request message of the first type originating from the second server computer (104). The request message of the first type may be received at the first server computer from the second server computer via one or more other server computers, networks, network switches or the like. For example, in some cases, the request message of the first type may be received at the first server computer from an acceptance network, a directory service, a payment network switch, an acquirer server computer, or the like.

The request message of the first type may include a first set of information including at least one static data element and the set of activity-related data elements. The static data element is a user-provided data element and the set of activity-related data elements are related to the activity (i.e. they may be generated for the activity and may uniquely describe the activity or aspects of the activity).

The static data element is linked to a trusted environment (141) provided by a secure element (143) and which stores a user-side cryptographic key (114B). The secure element is expected to be in the user's position. The user-side cryptographic key may be known only to and may be accessible only by the trusted environment. The static data element is linked at an issuer (110) to a server-side cryptographic key (114A) stored within a hardware security module and which corresponds to the user-side cryptographic key (114B). For example, the server-side cryptographic key is usable in decrypting cipher text generated by encrypting data elements using the user-side cryptographic key.

The first server computer may process (208) the activity-related data elements and associated information to determine whether a data element of the set of activity-related data elements exceeds a threshold predetermined for that data element given that the data elements are associated with the first security risk indicator. This may include processing the activity-related data elements to determine whether to convert the digital activity from the first type to a second type. This may include evaluating the data elements to determine a risk level, approval likelihood or approval rate, a cost or value associated therewith or the like. Evaluating the risk might include evaluating a fraud risk or fraud likelihood. Evaluating the approval likelihood might include comparing the likelihood of approval of a request of the second type for the activity as compared to a request of the first type for the activity. In some cases, if the risk level and/or value are low, the first server computer may allow processing to continue as normal without initiating conversion of the digital activity from the first type to the second type.

In some examples, a data element within the set of activity-related data elements represents an amount and the first server computer (102) may determine whether the amount exceeds a predetermined threshold. By configuring the first server computer in the manner described herein to carry out the method described herein, an issuer is provided with control as to deciding when to request enriched, activity-related information for an activity and consequently when to convert from a digital activity of the first type to the second type. This enables integration of the described systems and methods with security threat (or fraud-risk) processing such that security threats associated with activities can be mitigated on a per-activity basis at the discretion of or according to the configuration of the first server computer.

The first server computer (102) may identify (210) the user communication device linked to the first set of information. This may include querying one or more of an account database (111), a key store (112) and an enrollment database (116) to identify the user communication device. In some examples, identifying the user communication device is in response to a data element of the set of activity-related data elements exceeding a threshold predetermined for that data element. In other examples, identifying the user communication device is in response to the first server computer receiving the request message of the first type.

The first server computer (102) may transmit (212) a message including at least a data element of the set of activity-related data elements to the user communication device (106). The message may be configured to cause the user communication device to prompt a user thereof to perform a user action to initiate generation of a cryptographic token by a trusted environment linked to the first set of information. The message may for example include an instruction which causes an application executing on the user communication device to prompt the user to perform the action. The message may be a cryptographic token request message or a confirmation and enrichment request message. In some embodiments, the message may include a prompt to the user to approve or decline the activity, and the user action which the user is requested to perform may include or be representative of a user input approving the activity. The message may be transmitted from the first server computer to the user communication device via the data communication network (108). In some embodiments, the first server computer and the user communication device may establish a secure communication channel via which the message is sent. Establishing the secure communication channel may include using an application public-private keypair (132A, 132B) by way of which the user communication device confirms its authenticity to the first sever computer. In some embodiments the first server computer transmits the message to the user communication device when the amount exceeds the predefined threshold. The message may be sent to the first entity application (130) executing on the user communication device.

It should be appreciated that the user communication device (106) is remote from the first server computer and the second server computer. Further, in some cases, the user communication device may be an out-of-band communication device in that it is initially not a part of (e.g. it does not cause initiation of) the activity. Further, the user communication device is not a device of the second entity associated with the second server computer and no operator or physical interaction with the second entity associated with the second server computer is required.

The user communication device (106) may receive (214) the message including the set of activity-related data elements. The message may be received from the first server computer via the data communication network and may be configured to cause the user communication device to prompt a user thereof to perform a user action to initiate generation of a cryptographic token within or by a trusted environment. The message may be received by the first entity application executing on the user communication device.

The user communication device (106) may output (216) a prompt to the user to perform the user action. In some embodiments, the prompt requests the user to approve or decline the activity. In some embodiments, the prompt indicates that the user can present a smart card to the user communication device to approve the activity. In some embodiments, the prompt asks the user to click on a “continue” or other suitable button to approve the activity by using a digitized smart card stored within the user communication device. Example prompts are illustrated in FIGS. 4A-4C. In the example prompt (250) of FIG. 4A, the user is asked to tap their smart card in order to approve the digital transaction, or otherwise to click a “decline” button (251) if the user wishes not to approve the digital transaction (e.g. if fraud is suspected). The example prompt (252) of FIG. 4B is similar to that of FIG. 4A, but differs in that the user is asked to click a “continue” button (254) to authenticate the transaction using a digitized smart card. In the example prompt (256) of FIG. 4C, the user is asked to present a physical smart card or to continue with a digitized smart card by clicking on the “continue” (258) button. Although not shown, the prompts (252, 256) of FIGS. 4B and 4C may have decline options too. The method may include the communication device receiving user input in the form of either an instruction to continue with the activity or to decline the activity.

Returning to FIG. 3B, in response to the user performing the required user action (such as one prompted for in any of the prompts of FIGS. 4A-4C, including for example presenting a physical smart card by tapping it onto the user communication device, or clicking a “continue” or equivalent button), the user communication device (106) may obtain (218) a second set of information from a trusted environment provided by secure element provisioned to or physically proximate the user communication device (e.g. embodied in a smart card). The second set of information may be dynamic information. For example, the second set of information may be generated for and/or uniquely linked to the activity to which the first request message relates. For example, the user communication device (106) may obtain a cryptographic token from the trusted environment (141). This may include transmitting the set of activity-related data elements to the trusted environment and receiving the cryptographic token from the trusted environment. The cryptographic token may include or be in the form of cipher text produced by the trusted environment signing the set of activity-related data elements with the user-side cryptographic key (114B) stored within the trusted environment. The cryptographic token can be validated by the issuer using the server-side cryptographic key (114A) associated with the user-side cryptographic key.

The user communication device (106) may transmit (220) the second set of information to the first server computer for initiating a request message of the second type. For example, the user communication device (106) may transmit (220) the cryptographic token to the first server computer (102) for initiating a request message of the second type for the activity using the cryptographic token for transmission to an acceptance network. In some examples, the request message of the second type is a card-present request message. In some embodiments, the user communication device (106) transmits the cryptographic token to the first server computer (102) via the secure communication channel. In some embodiments, the user communication device (106) transmits the cryptographic token to the first server computer in a message which is signed using an application private key (132A) stored within the user communication device such that the server computer can validate the message using a corresponding application public key (132B) stored in the enrollment database (116).

The first server computer may wait to receive the second set of information from the user communication device. Depending on configuration, if the second set of information is not received within a predetermined period of time, the first server computer may transmit a response message to the second server computer indicating that the second server computer can continue to process the digital transaction as the first type (e.g. being card-not-present). Alternatively, the method may include the first server computer transmitting a response message declining the activity if the second set of information is not received within the predetermined period of time. In other words, converting the activity from the first type to the second type may be optional or may be forced (or mandatory) if the transaction is to continue.

The first server computer (102) may receive (222) the second set of information from the user communication device (106). In some embodiments, the second set of information including the cryptographic token is received in a message signed by the user communication device using the application private key securely stored therein. In such a case, the first server computer may validate the message (e.g. as to authenticity and/or origin) using a corresponding application public key stored in the enrollment database in association with the user.

The first server computer (102) may initiate (224) a request message of the second type using the second set of information. For example, the first server computer may initiate a card-present request for the activity using the cryptographic token. The server computer may transmit (225) a response message to the second server computer (106). In some embodiments, initiating the request message of the second type includes transmitting the response message including the cryptographic token to the second server computer for transmission of the request message of the second type, including the cryptographic token, by the second server computer to the acceptance network. Alternatively, in other examples, the response message transmitted to the second server computer declines the request message of the first type that had initially been sent by the second server computer to the first server computer. In this case, initiating the request message of the second type includes the first server computer transmitting the request message of the second type, including the cryptographic token, to the acceptance network on behalf of the second server computer. In some examples, the response message is one of: an Authentication Response Message (ARes), a Challenge Response Message (CRes) or a Results Request Message (RReq) in a 3DS or equivalent security protocol.

The second server computer (106) may receive (226) the response message from the first server computer. In some examples, the response message includes the cryptographic token having been obtained by the user communication device from the trusted environment. In other examples, the response message declines the request message of the first type and indicates that a request message of the second type has been initiated for or on behalf of the second server computer by the first server computer. If the response message includes the cryptographic token, the second server computer may transmit the cryptographic token to the acceptance network (120) as a request message of the second type.

Otherwise, if the user communication device receives an instruction from the user to decline the activity, the user communication device may transmit an activity declined message to the first server computer and the first server computer may terminate further processing relating to the activity and/or submit an appropriate response message to the second server computer.

An exemplary method for obtaining (218) the cryptographic token is illustrated in the swim-lane flow diagram of FIG. 5 in which respective swim-lanes delineate steps, operations or procedures performed by respective components or modules. The method may be conducted on the same device (e.g., in cases where the trusted environment is provided by a secure element embedded within the user communication device) or by separate devices (i.e., being the user communication device and a smart card providing the trusted environment in a secure element thereof). The steps or operations illustrated as being conducted outside of the trusted environment may be executed by an application executing on the user communication device. In some examples the application is a first entity application (130) while in other examples the application is a second entity application (122).

The method may include the application (130/122) initiating (300) communication with the trusted environment (141). Initiating communication may include establishing a communication channel with the trusted environment.

In a use case in which the trusted environment is provided by a smart card embodied in a smart card, initiating communication may include the user communication device initiating a proximity-based communication interface for connecting to the smart card and in turn the secure element thereof. The proximity-based communication interface may for example be a shortrange wireless communication interface, such as a near field communication-(NFC-) based or equivalent communication interface. The communication channel established may be a proximity-based communication channel. The proximity-based communication interface may use a contactless element of the user communication device and a corresponding contactless element embedded within the smart card.

In a use case in which the trusted environment is provided by a secure element embedded within the user communication device and to which a digitized smart card is provisioned, initiating communication may include the application (130/122) initiating or calling an inter-application communication interface for communicating with the trusted environment. The communication channel established may be a suitable inter-application communication channel.

The method may include the application (130,122) transmitting (302) the set of activity-related data elements to the trusted environment via the communication channel.

The method may include the trusted environment (141) receiving (304) the set of activity-related data elements from the application (130/122). The trusted environment may generate (306) a cryptographic token based on the set of activity-related data elements using the user-side cryptographic key (114B). This may include generating a cryptographic token in the form of cipher text by signing or encrypting the set of activity-related data elements using a signing/encryption algorithm and the user-side cryptographic key stored within the trusted environment. The user-side cryptographic key is stored within the trusted environment and is known and accessible only to the trusted environment (or the secure element providing the trusted environment). A corresponding server-side cryptographic key stored in a key store of the issuer can be used to validate the cryptographic token, for example by decrypting the ciphertext using the server-side cryptographic key and validating the data elements obtained. The trusted environment (141) may transmit (308) the cryptographic token to the application (130/122) via the communication channel.

The method may include the application (130/122) receiving (310) the cryptographic token from the trusted environment.

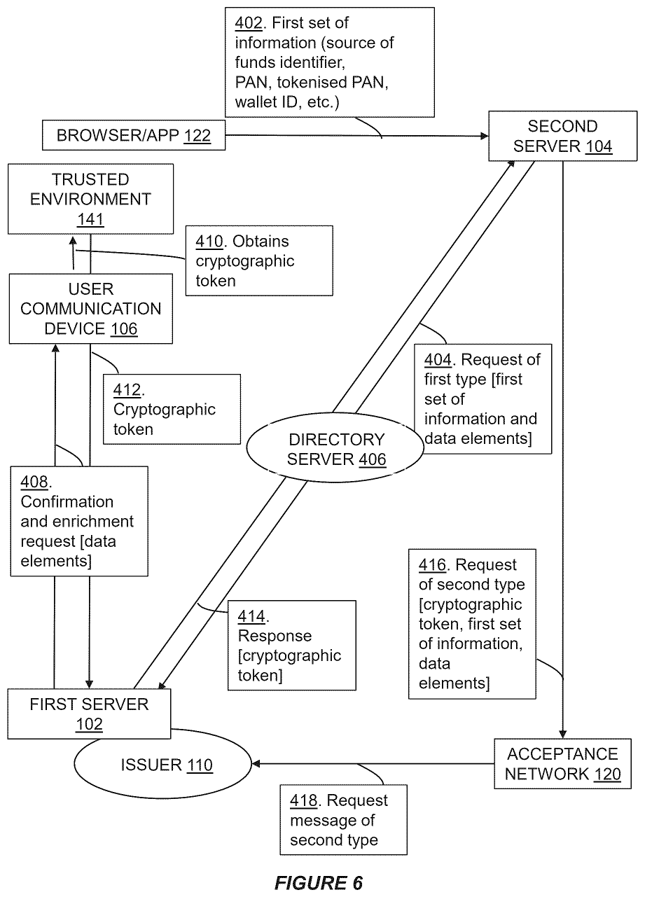

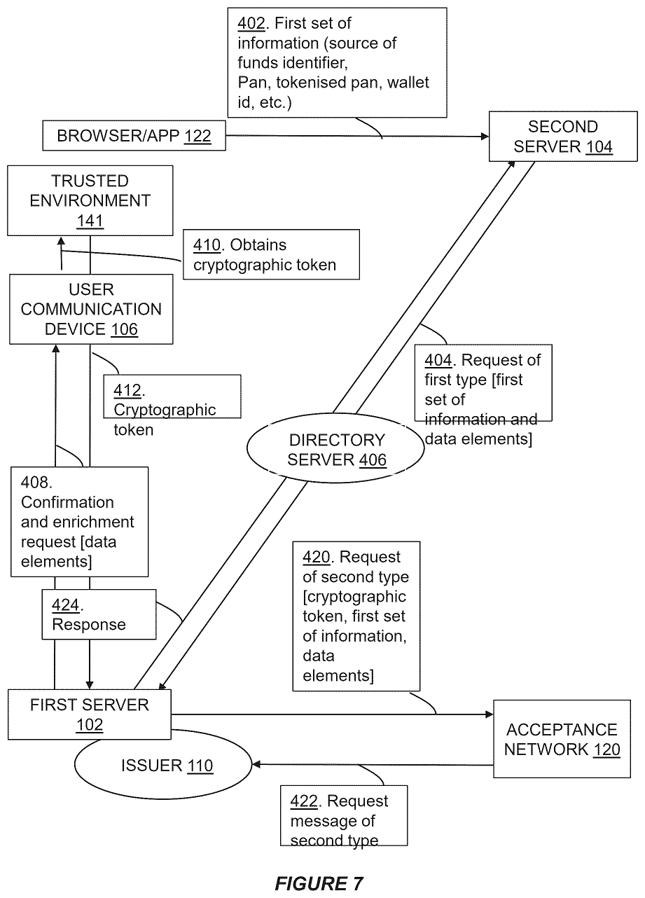

FIGS. 6 and 7 show example embodiments of a method for performing cryptographic operations for digital activity security in which type conversion is built into a security protocol designed to be an additional security layer for online credit and debit card transactions through which consumer consent or approval is sought before a payment request is transmitted. In the example embodiments illustrated in FIGS. 6 and 7, the protocol is the 3DS security protocol.

The method of both FIGS. 6 and 7 includes the browser or second entity application (122) providing (402) the first set of information to the second server computer (104) related to an activity the user is conducting with the second entity. The second server computer, acting as a 3DS requestor, transmits (404) the first set of information (or at least one static data element thereof) and a set of activity-related data elements relating to or describing the activity in a request message to the first server computer (102). The transmission is via a directory service (406) which is configured to route the request message received from the 3DS requestor to an access control server (ACS) of the appropriate issuer. The first server computer (102) receives the request, identifies the user communication device associated with the request (or the first set of information included in the request). The first server computer (102) transmits (408) a confirmation and enrichment request to the user communication device (106) which includes the set of activity-related data elements and which is configured to cause the user communication device to prompt (250, 252, 256) the user thereof to perform an activity to approve the request for the activity. The user communication device (106) outputs the prompt and, when the user performs the action (e.g. by bringing a physical smart card into proximity to the user communication device, or by selecting to continue with a digitized smart card stored within the user communication device), the user communication device obtains (410) a second set of information including a cryptographic token from the trusted environment (141) and returns (412) the second set of information to the first server computer (102).

In the example of FIG. 6, the first server computer generates a response message which includes the second set of information and transmits (414) the response message to the second server computer via the directory service (406). The second server computer receives the response message and cryptographic token and can then use the response message to submit (416) a request message of the second type (e.g. being a card-present request message) to the acceptance network (120), which in turn transmits (418) the request message of the second type to the issuer (110) for the issuer to process, which may include validating the second set of information using a server-side cryptographic key corresponding to the user-side cryptographic key used to generate the cryptographic token.

In the example of FIG. 7, the first server computer transmits (420) a request message of the second type to the acceptance network (120) on behalf of the second entity associated with the second server computer. The acceptance network in turn transmits (422) the request message of the second type to the issuer (110) for the issuer to process, which may include validating the second set of information using a server-side cryptographic key corresponding to the user-side cryptographic key used to generate the cryptographic token. The first server computer (102) may receive a confirmation or approval message from the acceptance network (120), for example confirming that the request associated with the request message of the second type has been approved, successfully processed, or the like. The first server computer may generate and transmit (424) to the second server computer via the directory service a response message which declines the request. Transmitting the response message may be in response to the first server computer receiving the confirmation or approval message from the acceptance network. The response message may indicate that the request associated with the request message of the first type has been declined because the issuer is in possession of the second set of information and has submitted a request message of the second type to the acceptance network on behalf of the second server computer. The response message may include details of the request message of the second type and/or of the approval or confirmation message such that the second server computer receives details of the request message of the second type and the associated confirmation or approval. Such details may for example include the activity related data elements, a digital transaction reference or the like.

In an alternative example to that illustrated in FIG. 7, in response to receiving (412) the second set of information from the user communication device (106), the first server computer (102) may generate and transmit to the second server computer via the directory service a response message that invokes a web page on the browser or a screen on the second entity application (122), as the case may be, which indicates that the request is being processed. For example, the response message may include a URL that directs the browser or second entity application (122) to an access control or similar server computer of the issuer that implements the security protocol. The first server computer may for example use the same rails of the security protocol that would conventionally be used to indicate that a challenge to the user is required or being initiated. In some embodiments, the response message may invoke a web page that indicates that the request is being processed by the first server computer submitting a request message of the second type to the acceptance network on behalf of the second entity associated with the second server computer. The response message may thus convey information to the user and/or the second entity associated with the second server computer that the request is being processed. Simultaneously or shortly thereafter, the first server computer may transmit a request message of the second type to the acceptance network (120) on behalf of the second entity associated with the second server computer. The acceptance network in turn may transmit the request message of the second type to the issuer (110) for the issuer to process, which may include validating the second set of information using a server-side cryptographic key corresponding to the user-side cryptographic key used to generate the cryptographic token. The first server computer (102) may receive a confirmation or approval message from the acceptance network (120), for example confirming that the request associated with the request message of the second type has been approved, successfully processed. The first server computer may update the web page to indicate successful completion before redirecting the browser or second entity application (122) to second entity's domain.

It should be apparent from FIGS. 6 and 7 that conventional transaction processing rails or channels may be used, with minimal changes needing to be made to the request and response messages. This may facilitate integration of the systems and methods described herein, which may increase adoption and thus allow for improved security. Further, embodiments of the described system and method can use an existing security protocol to obtain enriched, activity-related information for improving security and enabling transaction-type conversion on the basis of the enriched information.

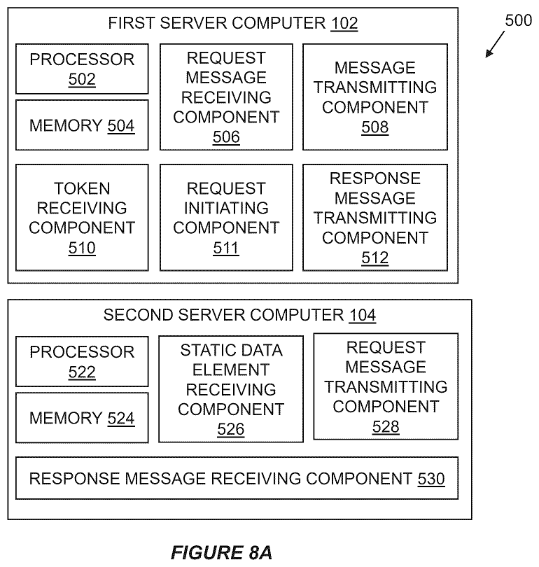

Various components may be provided for implementing the methods described above with reference to FIGS. 3A to 7. FIGS. 8A and 8B are a block diagrams which illustrate exemplary components which may be provided by a system (500, 501) for performing cryptographic operations for digital activity security according to aspects of the present disclosure. The system includes a first server computer (102), a second server computer (104) and a user communication device (106).

The first server computer (102) may include a processor (502) for executing the functions of components described below, which may be provided by hardware or by software units executing on the first server computer (102). The software units may be stored in a memory component (504) and instructions may be provided to the processor (502) to carry out the functionality of the described components. The first server computer (102) may include a request message receiving component (506) arranged to receive a request message of the first type related to an activity and originating from the second server computer (106). The first server computer (102) may include a message transmitting component (508) arranged to transmit a message including the set of activity-related data elements to the user communication device (106). The message may be configured to cause the user communication device to prompt a user thereof to perform a user action to initiate generation of a cryptographic token by a trusted environment which stores a user-side cryptographic key. The first server computer (102) may include a cryptographic token receiving component (510) arranged to receive the cryptographic token from the user communication device. The first server computer (102) may include a request initiating component (511) arranged to initiate a request of a second type for the activity using the cryptographic token for transmission to an acceptance network (120). The first server computer (102) may include a response message transmitting component (512) arranged to transmit a response message to the second server computer.

The second server computer (104) may include a processor (522) for executing the functions of components described below, which may be provided by hardware or by software units executing on the second server computer (104). The software units may be stored in a memory component (524) and instructions may be provided to the processor (522) to carry out the functionality of the described components. The second server computer (104) may include a static data element receiving component (526) arranged to receive a static data element from a remote user. The second server computer (104) may include a request message transmitting component (528) arranged to transmit, to the first server computer, a request message of the first type related to an activity and including the static data element and a set of activity-related data elements. The second server computer (104) may include a response message receiving component (530) arranged to receive, from the first server computer, a response message which indicates initiation of or is usable in initiating a request of the second type for the activity using a cryptographic token having been obtained by a user communication device from a trusted environment for transmission to an acceptance network.

The user communication device (106) may include a processor (532) for executing the functions of components described below, which may be provided by hardware or by software units executing on the user communication device (106). The software units may be stored in a memory component (534) and instructions may be provided to the processor (532) to carry out the functionality of the described components. Some or all of the components may be provided by an application (130/122) downloadable onto and executable on the user communication device (106).

The user communication device (106) may include a message receiving component (536) arranged to receive, from the first server computer, a message including a set of activity-related data elements and being configured to cause the user communication device to prompt a user thereof to perform a user action to initiate generation of a cryptographic token by or within a trusted environment.

The user communication device (106) may include a prompt outputting component (538) and an output component (539). The output component may for example be in the form of or include a display, speaker or other mechanism for outputting information to the user. The prompt outputting component (538) may be arranged to output, via the output component (539), a prompt to the user to perform the user action.

The user communication device (106) may include a cryptographic token obtaining component (540) arranged to obtain, in response to the user performing the user action, the cryptographic token from the trusted environment (141). The cryptographic token obtaining component (540) may include a data element transmitting component (542) arranged to transmit the set of activity-related data elements to the trusted environment (141) and a cryptographic token receiving component (544) arranged to receive the cryptographic token from the trusted environment (141). The cryptographic token includes cipher text produced by the trusted environment (141) signing the set of activity-related data elements with a user-side cryptographic key (114B) stored within the trusted environment. The trusted environment may be provided by a secure element (143), which may be embedded within the user communication device or which may be provided by an external smart card.

The user communication device (106) may include a cryptographic token transmitting component (546) arranged to transmit the cryptographic token to the first server computer for initiating a request of the second type for the activity using the cryptographic token for transmission to an acceptance network.

Aspects of the present disclosure provide a system and method for digital activity type-conversion in which a user presents a static data element (e.g. being user credentials, such as a PAN, CVV2, etc.). Aspects of the present application provide a system and method for, during the user authentication, upgrading the static data element to information originating from a full digital card (e.g. being a physical or digitized smart card). This second set of information may include full track 2 data and a cryptographic token (or payment cryptogram) that has been signed on that card, using transaction details as input. Aspects of the present disclosure may provide for two modes of operation, being:
A two-step process (Challenge+Merchant submit): Issuer is challenged to get user consent and provide proof back. The merchant entity then submits the transaction. In this mode, the first server computer returns the second set of information, rather than just the 3D Secure cryptogram. The merchant then submits those fields in their payment transaction request.
Single process: Transaction is submitted to Issuer for processing. Somewhere in the middle (could be at network switch or at issuer or acquirer) the first server computer detects card-not-present and upgrades the transaction. The first server computer reaches out to the customer and injects the second set of information fields into the transaction as it processes upstream. Once the first server computer receives the response back it can then return that result to the originating merchant.

Aspects of the present disclosure provide a method and system for conversion from card-not-present to card-present transactions for high value or high risk transactions. An example method may include receiving an authorisation request relating to a card-not-present (CNP) transaction. The authorisation request may include CNP user credentials. The method may include evaluating a value of the transaction against a threshold. When the value exceeds the threshold, the method may include transmitting a pop-up notification to a registered user device associated with the CNP user credentials to present a card associated with the CNP user credentials to the registered device. The method may include receiving and validating a cryptogram generated by and associated with the card. When the cryptogram is valid, the method may include submitting the transaction as a card-present transaction based on the cryptogram received from the registered user device. The notification may indicate an incentive, for example a higher loyalty rate for the transaction, a discount on the transaction value or the like. Advantages of the proposed solution may include: a) the card-present interchange fees are lower than card-not-present interchange fees for a merchant; and b) the solution adds a layer of security to the transaction, as the user initiating the purchase also has to be in possession of the card, thereby limiting fraudulent transactions by hackers, etc.

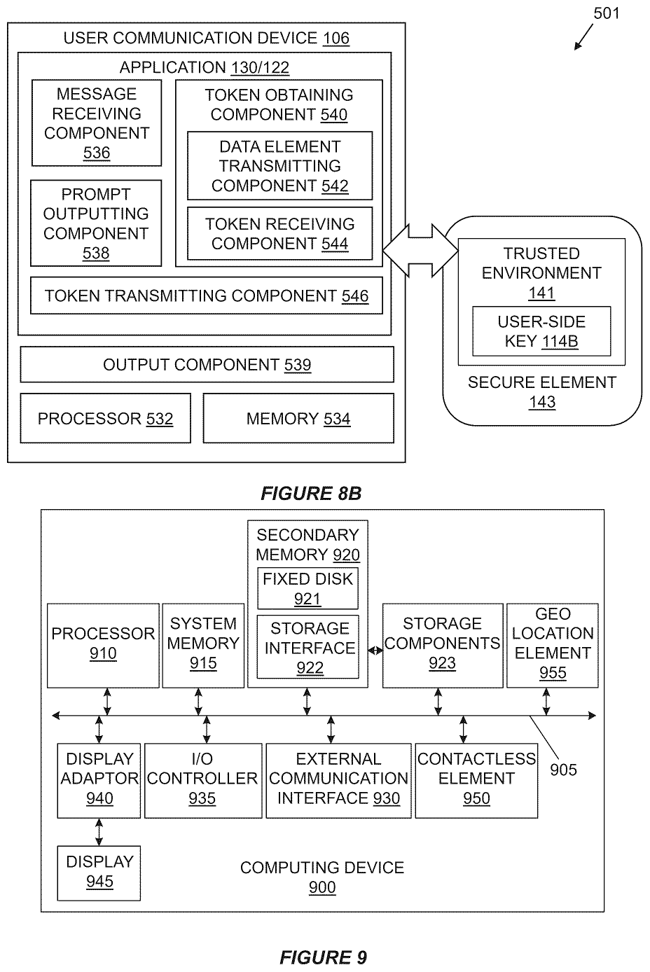

FIG. 9 illustrates an example of a computing device (900) in which various aspects of the disclosure may be implemented. The computing device (900) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (900) may be suitable for storing and executing computer program code. The various participants and elements in the previously described system diagrams may use any number of subsystems or components of the computing device (900) to facilitate the functions described herein. The computing device (900) may include subsystems or components interconnected via a communication infrastructure (905) (for example, a communications bus, a network, etc.). The computing device (900) may include one or more processors (910) and at least one memory component in the form of computer-readable media. The one or more processors (910) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (900) may be distributed over a number of physical locations (e.g. in a distributed, cluster or cloud-based computing configuration) and appropriate software units may be arranged to manage and/or process data on behalf of remote devices.

The memory components may include system memory (915), which may include read only memory (ROM) and random access memory (RAM). A basic input/output system (BIOS) may be stored in ROM. System software may be stored in the system memory (915) including operating system software. The memory components may also include secondary memory (920). The secondary memory (920) may include a fixed disk (921), such as a hard disk drive, and, optionally, one or more storage interfaces (922) for interfacing with storage components (923), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (900) may include an external communications interface (930) for operation of the computing device (900) in a networked environment enabling transfer of data between multiple computing devices (900) and/or the Internet. Data transferred via the external communications interface (930) may be in the form of signals, which may be electronic, electromagnetic, optical, radio, or other types of signals. The external communications interface (930) may enable communication of data between the computing device (900) and other computing devices including servers and external storage facilities. Web services may be accessible by and/or from the computing device (900) via the communications interface (930).

The external communications interface (930) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (930) may include a subscriber identity module (SIM) in the form of an integrated circuit that stores an international mobile subscriber identity and the related key used to identify and authenticate a subscriber using the computing device (900). One or more subscriber identity modules may be removable from or embedded in the computing device (900).

The external communications interface (930) may further include a contactless element (950), which is typically implemented in the form of a semiconductor chip (or other data storage element) with an associated wireless transfer element, such as an antenna. The contactless element (950) may be associated with (e.g., embedded within) the computing device (900) and data or control instructions transmitted via a cellular network may be applied to the contactless element (950) by means of a contactless element interface (not shown). The contactless element interface may function to permit the exchange of data and/or control instructions between computing device circuitry (and hence the cellular network) and the contactless element (950). The contactless element (950) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (900) and an interrogation device. Thus, the computing device (900) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (910). A computer program product may be provided by a non-transient or non-transitory computer-readable medium, or may be provided via a signal or other transient or transitory means via the communications interface (930).

Interconnection via the communication infrastructure (905) allows the one or more processors (910) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (900) either directly or via an I/O controller (935). One or more displays (945) (which may be touch-sensitive displays) may be coupled to or integrally formed with the computing device (900) via a display or video adapter (940).

The computing device (900) may include a geographical location element (955) which is arranged to determine the geographical location of the computing device (900). The geographical location element (955) may for example be implemented by way of a global positioning system (GPS), or similar, receiver module. In some implementations the geographical location element (955) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (900). In some implementations, the geographical location element (955) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon.

Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method conducted at a first server computer comprising:
receiving a request message of a first type related to an activity, the request message of the first type including a static data element and an activity-related data element and being associated with a first indicator, wherein the static data element is associated with a user communication device;
transmitting a message including the activity-related data element to the user communication device, the message being configured to cause the user communication device to prompt a user thereof to perform a user action to initiate generation of a cryptographic token in a trusted environment which stores a user-side cryptographic key;
receiving the cryptographic token from the user communication device, the cryptographic token having been obtained by the user communication device from the trusted environment and including cipher text produced by the trusted environment signing the activity-related data element with the user-side cryptographic key stored within the trusted environment; and,
initiating a request of a second type for the activity using the cryptographic token for transmission to an acceptance network, wherein the request of the second type is associated with a second indicator.

2. The method as claimed in claim 1, wherein the static data element is linked at an issuer to the trusted environment, wherein the static data element is linked to a server-side cryptographic key stored within a hardware security module and which corresponds to the user-side cryptographic key, and wherein the server-side cryptographic key is usable in validating the cryptographic token.

3. The method as claimed in claim 1, including:
processing the activity-related data element to determine whether the activity-related data element exceeds a predetermined threshold; and,
identifying the user communication device in response to determining that the activity-related data element exceeds the predetermined threshold.

4. The method as claimed in claim 1, wherein the request message of the first type originates from a second server computer, wherein initiating the request of the second type for the activity using the cryptographic token includes transmitting a response message to the second server computer.

5. The method as claimed in claim 4, wherein initiating the request of the second type includes transmitting the response message including the cryptographic token to the second server computer for transmission, by the second server computer to the acceptance network, of a request message of the second type including the cryptographic token.

6. The method as claimed in claim 4, wherein initiating the request of the second type includes transmitting, from the first server computer, a request message of the second type including the cryptographic token to the acceptance network on behalf of the second server computer, and wherein the response message declines the request message of the first type.

7. The method as claimed in claim 1, wherein the request message of the first type having been generated at a second server computer in response to the second server computer receiving the static data element from a remote user.

8. The method as claimed in claim 4, wherein the second server computer is a 3DS requestor and the user is a 3DS client in a security protocol, wherein the request message of the first type is one of: an Authentication Request Message (AReq) or a Challenge Request Message (CReq) in the security protocol, and wherein the response message is one of: an Authentication Response Message (ARes), a Challenge Response Message (CRes) or a Results Request Message (RReq) in the security protocol.

9. The method as claimed in claim 1, wherein the first indicator is a first security risk indicator and the second indicator is a second security risk indicator, and wherein the second security risk indicator indicates a lower security risk than the first security risk indicator.

10. The method as claimed in claim 1, conducted at a second server computer comprising:
receiving the static data element from a remote user;
transmitting, to the first server computer, the request message of the first type related to the activity and including the static data element and the activity-related data element, wherein the request message of the first type is associated with the first indicator;
receiving, from the first server computer, a response message which indicates initiation of or is usable in initiating the request of the second type for the activity using the cryptographic token having been obtained by the user communication device from the trusted environment for transmission to the acceptance network, wherein the request of the second type is associated with the second indicator.

11. The method as claimed in claim 10, wherein the response message includes the cryptographic token including cipher text produced by the trusted environment signing the activity-related data element with a user-side cryptographic key stored within the trusted environment, and wherein the method includes transmitting the cryptographic token to the acceptance network in a request message of the second type.

12. The method as claimed in claim 1, conducted at the user communication device comprising:
receiving, from the first server computer, the message including the activity-related data element and being configured to cause the user communication device to prompt the user thereof to perform the user action to initiate generation of the cryptographic token by the trusted environment, the activity-related data element having been received at the first server computer with the static data element in the request message of the first type related to the activity, wherein the request message of the first type is associated with the first indicator;
outputting, via an output component of the user communication device, a prompt to the user to perform the user action;
in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with the user-side cryptographic key stored within the trusted environment; and,
transmitting the cryptographic token to the first server computer for initiating the request of the second type for the activity using the cryptographic token for transmission to the acceptance network, wherein the request of the second type is associated with the second indicator.

13. The method as claimed in claim 12, wherein the trusted environment is provided by a secure element embedded within the user communication device or provided on a smart card external to the user communication device.

14. The method as claimed in claim 13, wherein the user action is a proximity-based presentation of the smart card to the user communication device.

15. The method as claimed in claim 12, wherein the cryptographic token is obtained by the user communication device from the trusted environment via a proximity communication interface over which the user communication device transmits the activity-related data element to the trusted environment and the trusted environment transmits the cryptographic token to the user communication device.

16. A system including a first server computer comprising: a first non-transitory computer-readable storage medium; and one or more first processors coupled to the first non-transitory computer-readable storage medium, wherein the first non-transitory computer-readable storage medium comprises program instructions that, when executed on the one or more first processors, cause the first server computer to perform operations comprising:
receiving a request message of a first type related to an activity, the request message of the first type including a static data element and an activity-related data element and being associated with a first indicator, wherein the static data element is associated with a user communication device;
transmitting a message including the activity-related data element to the user communication device, the message being configured to cause the user communication device to prompt a user thereof to perform a user action to initiate generation of a cryptographic token in a trusted environment which stores a user-side cryptographic key;
receiving the cryptographic token from the user communication device, the cryptographic token having been obtained by the user communication device from the trusted environment and including cipher text produced by the trusted environment signing the activity-related data element with the user-side cryptographic key stored within the trusted environment; and,
initiating a request of a second type for the activity using the cryptographic token for transmission to an acceptance network, wherein the request of the second type is associated with a second indicator.

17. The system as claimed in claim 16, including a second server computer comprising: a second non-transitory computer-readable storage medium; and one or more second processors coupled to the second non-transitory computer-readable storage medium, wherein the second non-transitory computer-readable storage medium comprises program instructions that, when executed on the one or more second processors, cause the second server computer to perform operations comprising:
receiving the static data element from a remote user;
transmitting, to the first server computer, the request message of the first type related to the activity and including the static data element and the activity-related data element;
receiving, from the first server computer, a response message which indicates initiation of or is usable in initiating the request of the second type for the activity using the cryptographic token having been obtained by the user communication device from the trusted environment for transmission to the acceptance network.

18. The system as claimed in claim 16, including the user communication device comprising: a device non-transitory computer-readable storage medium; and one or more device processors coupled to the device non-transitory computer-readable storage medium, wherein the device non-transitory computer-readable storage medium comprises program instructions that, when executed on the one or more device processors, cause the user communication device to perform operations comprising:
receiving, from the first server computer, the message including the activity-related data element and being configured to cause the user communication device to prompt a user thereof to perform the user action to initiate generation of the cryptographic token by the trusted environment, the activity-related data element having been received at the first server computer with the static data element in the request message of the first type related to the activity;
outputting, via an output component of the user communication device, a prompt to the user to perform the user action;
in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with the user-side cryptographic key stored within the trusted environment; and,
transmitting the cryptographic token to the first server computer for initiating the request of the second type for the activity using the cryptographic token for transmission to the acceptance network.

19. The system as claimed in claim 16, wherein the static data element is linked at an issuer to the trusted environment, wherein the static data element is linked to a server-side cryptographic key stored within a hardware security module and which corresponds to the user-side cryptographic key, wherein the server-side cryptographic key is usable in validating the cryptographic token, and wherein the trusted environment is provided by a secure element embedded within the user communication device or provided on a smart card external to the user communication device.

20-22. (canceled)

23. A computer program product comprising a computer-readable medium having stored computer-readable program code for performing the steps of:
receiving, from a first server computer, a message including an activity-related data element and being configured to cause the user communication device to prompt a user thereof to perform a user action to initiate generation of a cryptographic token by a trusted environment, the activity-related data element having been received at the first server computer with a static data element in a request message of a first type related to an activity, wherein the request message of the first type is associated with a first indicator;
outputting, via an output component of the user communication device, a prompt to the user to perform the user action;
in response to the user performing the user action, obtaining the cryptographic token from the trusted environment, including transmitting the activity-related data element to the trusted environment and receiving the cryptographic token from the trusted environment, the trusted environment including cipher text produced by the trusted environment signing the activity-related data element with a user-side cryptographic key stored within the trusted environment; and,
transmitting the cryptographic token to the first server computer for initiating a request of a second type for the activity using the cryptographic token for transmission to an acceptance network, wherein the request of the second type is associated with a second indicator.

24. (canceled)
